(19) United States
(12) Patent Application Publication
(10) Pub. No.: US 2007/0137529 A1
(43) Pub. Date: Jun. 21, 2007

(54) Cationic cellulose ethers as fluid loss control additives in cement compositions and associated methods

(76) Inventors: Jiten Chatterji, Duncan, OK (US); Roger S. Cromwell, Walters, OK (US); D. Chad Brenneis, Marlow, OK (US)

Correspondence Address: CRAIG W. RODDY;HALLIBURTON ENERGY SERVICES, P.O. BOX 1431, DUNCAN, OK, 73536-0440, US

(21) Appl. No.: 11/314,391

(22) Filed: Dec. 21, 2005

(51) Int. Cl. C04B 24/00; C04B 40/00

(52) U.S. Cl. 106/724; 106/819; 106/823

(57) ABSTRACT

Methods of cementing comprising: providing a cement composition comprising a cement, water, and a fluid loss control additive comprising a cationic cellulose ether, the cationic cellulose ether comprising a backbone of anhydroglucose units and a plurality of positively charged substituent groups spaced along the backbone; placing the cement composition into a location to be cemented; and allowing the cement composition to set therein. Cement compositions comprising a cement; water, and a fluid loss control additive comprising a cationic cellulose ether, the cationic cellulose ether comprising a backbone of anhydroglucose units and a plurality of positively charged substituent groups spaced along the backbone. Fluid loss control additives comprising: a cationic cellulose ether, the cationic cellulose ether comprising a backbone of anhydroglucose units and a plurality of positively charged substituent groups spaced along the backbone; and a dispersant.

### CROSS-REFERENCE TO RELATED APPLICATIONS

The present invention is related to U.S. patent application Ser. No. ______, Attorney Docket No. HES 2005-IP-0189908U1, entitled “Cationic Cellulose Ethers as Fluid Loss Control Additives in Cement Compositions and Associated Methods,” filed on the same date herewith, the entire disclosure of which is incorporated herein by reference.

### BACKGROUND

The present invention relates to cementing operations, and more particularly, to cationic cellulose ethers as fluid loss control additives for cement compositions and associated methods of use.

Hydraulic cement compositions are commonly utilized in subterranean operations. For example, hydraulic cement compositions are used in primary cementing operations whereby pipe strings such as casings and liners are cemented in well bores. In performing primary cementing, hydraulic cement compositions are pumped into the annular space between the walls of a well bore and the exterior surface of the pipe string disposed therein. The cement composition is permitted to set in the annular space, thereby forming an annular sheath of hardened substantially impermeable cement therein that substantially supports and positions the pipe string in the well bore and bonds the exterior surface of the pipe string to the walls of the well bore. Hydraulic cement compositions are also used in plugging and abandonment operations as well as in remedial cementing operations such as plugging permeable zones or fractures in well bores, plugging cracks and holes in pipe strings, and the like.

For such well cementing operations to be successful, the cement compositions utilized should include a fluid loss control additive to reduce the loss of fluid, e.g., water, from the cement compositions when they contact permeable subterranean formations and zones. Excessive fluid loss, inter alia, causes a cement composition to be prematurely dehydrated, which limits the amount of cement composition that can be pumped, which can excessive pump pressure that may cause the breakdown of the formation and/or the collapse of the walls of the well bore. Fluid loss control agents may also be used in surface cement compositions for similar reasons.

Cellulosic materials have been used as fluid loss control additives in cement compositions. Traditionally, these cellulosic materials could be classified as primarily non-ionic or anionic. Nonionic cellulosic materials are typically different grades of hydroxyethyl cellulose having varied molecular weights and varied moles of substitution of ethylene oxide. Anionic cellulosic materials are typically carboxymethylhydroxyethyl cellulose having different degrees of substitution with regard to the carboxyethylmethyl and varied moles of substitution of ethylene oxide.

The present invention relates to cementing operations, and more particularly, to cationic cellulose ethers as fluid loss control additives for cement compositions and associated methods of use.

In one embodiment, the present invention provides a cement composition comprising a cement; water, and a fluid loss control additive comprising a cationic cellulose ether, the cationic cellulose ether comprising a backbone of anhydroglucose units and a plurality of positively charged substituent groups spaced along the backbone.

Another embodiment of the present invention provides a fluid loss control additive comprising: a cationic cellulose ether, the cationic cellulose ether comprising a backbone of anhydroglucose units and a plurality of positively charged substituent groups spaced along the backbone; and a dispersant.

The features and advantages of the present invention will be readily apparent to those skilled in the art. While numerous changes may be made by those skilled in the art, such changes are within the spirit of the invention.

The present invention relates to cementing operations, and more particularly, to cationic cellulose ethers as fluid loss control additives for cement compositions and associated methods of use.

The cement compositions of the present invention generally comprise a cement, water, and a fluid loss control additive comprising a cationic cellulose ether, the cationic cellulose ether comprising a backbone of anhydroglucose units and a plurality of positively charged substituent groups spaced along the backbone.

The cement compositions of the present invention should have a density suitable for a particular application as desired by those of ordinary skill in the art, with the benefit of this disclosure. In some embodiments, the cement compositions of the present invention may have a density in the range of from about 8 pounds per gallon (“ppg”) to about 18 ppg. As those of ordinary skill in the art will appreciate, the cement compositions of the present invention may be foamed or unfoamed or may comprise other means, such as microspheres, to reduce their densities.

Any cement suitable for use in the desired application may be suitable for use in the cement compositions of the present invention. While a variety of cements may be suitable, in some embodiments, the cement compositions of the present invention may comprise a hydraulic cement. A variety of hydraulic cements may be utilized in accordance with the present invention, including, but not limited to, those that comprise calcium, aluminum, silicon, oxygen, and/or sulfur, which set and harden by reaction with water. Suitable hydraulic cements, include, but are not limited to, Portland cements, pozzolana cements, gypsum cements, high alumina content cements, slag cements, and silica cements, and combinations thereof. In certain embodiments, the hydraulic cement may comprise a Portland cement. In some embodiments, the Portland cements that may be suitable for use in the present invention are classified as Class A, C, G and H according to American Petroleum Institute, API Specification for Materials and Testing for Well Cements, API Specification 10, 5^{th} Edition, Jul. 1, 1990.

The water present in the cement compositions of the present invention may be from any source, provided that it does not contain an excess of compounds that adversely affect other compounds in the cement compositions. For example, a cement composition of the present invention may comprise freshwater, saltwater (e.g., water containing one or more salts dissolved therein), brine (e.g., saturated saltwater), seawater, or combinations thereof. The water may be present in an amount sufficient to form a pumpable slurry. Generally, the water is present in the cement compositions of the present invention in an amount in the range of from about 33% to about 200% by weight of cement (“bwoc”) therein. In certain embodiments, the water is present in the cement compositions of the present invention in an amount in the range of from about 35% to about 70% bwoc therein.

The fluid loss control additives in the cement compositions of the present invention generally comprise a cationic cellulose ether comprising a backbone of anhydroglucose units and a plurality of positively charged substituent groups spaced along this anhydroglucose backbone. Generally, the plurality of positively charged substituent groups spaced along the anhydroglucose backbone of these cationic cellulose ethers are ether groups that may comprise, inter alia, a quaternary-nitrogen radical. Additional ether groups which do not contain a quaternary-nitrogen radical may also be present.

In some embodiments, the cationic cellulose ethers may be of Formula I: 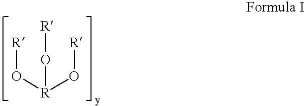
wherein R is the anhydroglucose backbone (e.g., C₆H₁₀O₅), the R's may be the same or different and each R′ individually represent a substituent group of Formula II below, and y represents the degree of polymerization having a value of from about 50 to about 20,000, or more, and preferably from about 200 to about 5,000.

Each R′ in Formula I above is individually a substituent group of Formula II below: 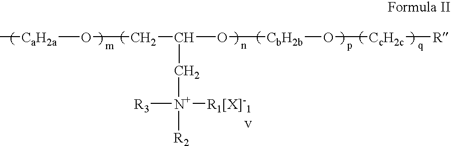
wherein:

a is in an integer having a value of from 2 to 3;

b is an integer having a value of from 2 to 3;

c is an integer having a value of from 1 to 3;

m is an integer having a value of from 0 to 10;

n is an integer having a value of from 0 to 3;

p is an integer having a value from 0 to 10;

q is an integer having a value from 0 to 1;

R″ is a member selected from the group consisting of: 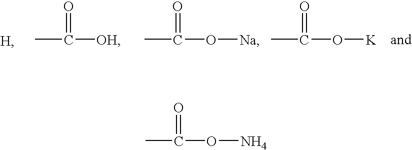
wherein when q is 0, R″ is H;

R₁, R₂, and R₃, taken individually, may represent a member selected from the group consisting of alkyl, aryl, aralkyl, alkaryl, cycloalkyl, alkoxyalkyl and alkoxyaryl radicals where each R₁, R₂, and R₃ can contain up to 10 carbon atoms, wherein when the member is an alkoxyalkyl radical, there are at least 2 carbon atoms separating the oxygen atom from the nitrogen atom, and wherein the total number of carbon atoms in radicals represented by R₁, R₂, and R₃ is from 3 to 12;

R₁, R₂, and R₃, taken together along with the nitrogen atom to which they are attached, represent a member selected from the group consisting of pyridine, α-methylpyridine, 3,5-dimethylpyridine, 2,4,6-trimethylpyridine, N-methyl piperidine, N-ethyl piperidine, N-methyl morpholine, and N-ethyl morpholine;

X is an anion such as chloride, bromide, iodide, sulfate, methylsulfate, sulfonate, nitrate, phosphate, acetate, and the like, and V is an integer which is equal to the valence of X;

the average value of n per anhydroglucose unit is from about 0.01 to about 1 and, in some embodiments, from about 0.1 to about 0.5; and

the average value of m+n+p+q per anhydroglucose unit is from about 0.01 to about 4, in some embodiment, from about 0.1 to about 2.5, and, in some embodiments, from about 0.8 to about 2.

A variety of polymers may be used as suitable cellulose ethers to which, inter alia, a quaternary-nitrogen radical may be added. One example of a suitable cellulose ether is hydroxyethyl cellulose with from about 2 to about 2.5 moles of ethylene oxide substitution.

Generally, the cationic cellulose ethers included in the fluid loss control additives in the cement compositions of the present invention may be manufactured in accordance with any suitable technique for polymer manufacture. The preparation of suitable cationic cellulose ethers is described in U.S. Pat. No. 3,472,840, the disclosure of which is incorporated herein by reference. One example of a commercially available cationic cellulose ether is available from Amerchol, Co., a division of Dow Chemical Company under the trade name UCARE™ Polymer LK. A 2% by weight solution of UCARE™ Polymer LK has a viscosity in the range of from about 300 centipoise to about 500 centipoise, as measured by a Brookfield viscometer at 25° C., and a nitrogen content in the range of from about 0.4% to about 0.6% by weight.

The amount of the cationic cellulose ether to include in the fluid loss control additive is dependent on a variety of factors, including, but not limited to, the desired level of fluid loss control. In some embodiments, the cationic cellulose ether may be present in the fluid loss control additive in an amount in the range of from about 30% to about 100% by weight of the fluid loss control additive. In some embodiments, the cationic cellulose either may be present in the fluid loss control additive in an amount in the range of from about 30% to about 50% by weight of the fluid loss control additive.

The fluid loss control additive in the cement compositions of the present invention may optionally comprise a dispersant. Where present, the dispersant in the fluid loss control additive acts, inter alia, to control the rheology of the cement composition and to stabilize the cement composition over a broad density range. While a variety of dispersants known to those skilled in the art may be used in accordance with the present invention, one suitable dispersant comprises a graft copolymer having a backbone of a condensation product of formaldehyde, acetone and sodium bisulfite, commercially available under the trade name CFR-8™ cement dispersant from Halliburton Energy Services, Inc., Duncan, Okla. Another example of a suitable dispersant is a condensation product of ketone, aldehyde, and compound introducing acid groups. Examples of these types of condensation products are condensation products of acetone, formaldehyde, and sodium bisulfite, and those in U.S. Pat. No. 4,818,288, the disclosure of which is incorporated herein by reference. Another example of a suitable dispersant is a polyamide graft copolymer containing at least one side chain formed from aldehydes and sulfur-containing acids or their salts. Examples of these types of copolymers are condensation products of sodium napthalene sulfonic acid and formaldehyde, and those in U.S. Pat. No. 6,681,856, the disclosure of which is incorporated herein by reference. Combinations of suitable dispersants also may be used. In some embodiments, the dispersant is present in the fluid loss control additive in an amount in the range of from about 5% to about 70% by weight. In one embodiment, the dispersant is present in the fluid loss control additive in an amount in the range of from about 50% to about 70% by weight.

Generally, the fluid loss control additive should be present in the cement compositions of the present invention in an amount sufficient to provide the desired fluid loss control. In some embodiments, the fluid loss control additive may present in the cement compositions of the present invention in an amount in the range from about 0.5% to 2% bwoc.

Optionally, other additional additives may be added to the cement compositions of the present invention as deemed appropriate by one skilled in the art, with the benefit of this disclosure. Examples of such additives include, but are not limited to, accelerators, set retarders, weight reducing additives, heavyweight additives, lost circulation materials, filtration control additives, foaming agents, defoamers, salts, vitrified shale, fly ash, fiber, strength retrogression additives and combinations thereof. For example, a strength retrogression additive, such as crystalline silica, may be used to prevent high-temperature strength retrogression that occurs to set cement compositions in high-temperature wells. Examples of suitable crystalline silica are SSA-1 and SSA-2 strength stabilization agents, from Halliburton Energy Services, Inc., Duncan, Okla. One of ordinary skill in the art, with the benefit of this disclosure, will be able to recognize where a particular additive is suitable for a particular application.

An example of a method of cementing of the present invention comprises: providing a cement composition comprising a cement, water and a fluid loss control additive comprising a cationic cellulose ether, the cationic cellulose ether comprising a backbone of anhydroglucose units and a plurality of positively charged substituent groups spaced along the backbone; placing the cement composition into a location to be cemented; and allowing the cement composition to set therein. The location to be cemented may be above ground or in a subterranean formation. For example, the cement composition may be placed into an annulus between a pipe string located in a well bore and a subterranean formation penetrated by the well bore.

To facilitate a better understanding of the present invention, the following examples of certain aspects of some embodiments are given. In no way should the following examples be read to limit, or define, the entire scope of the invention.

### EXAMPLE 1

Sample cement compositions having densities of 16.4 ppg were prepared that comprised water, Portland cement, SSA-2 strength stabilization agent (35% bwoc), and HR®-5 retarder (0.2% bwoc). HR®-5 retarder is a sulfomethylated lignin, available from Halliburton Energy Services, Inc. Sample Cement Composition No. 1 did not include a fluid loss control additive. Sample Cement Composition Nos. 2-8 included a fluid loss control additive in an amount of 1% bwoc. The composition of the fluid loss control additive used in each sample is depicted in Table 1.

After preparation, each sample cement composition was poured into a preheated cell with a 325 mesh screen, and a fluid loss test was performed for 30 minutes at 1000 psi and the temperature listed in Table 1 below. The fluid loss tests were performed in accordance with API RP 10B, Recommended Practices for Testing Well Cements. Additionally, the rheological properties of sample cement compositions were also determined using a Fann® Model 35 viscometer at 80° F. in accordance with the above mentioned API Specification RP 10B. The results of the tests are given in Table 1 below.

TABLE 1
API Fluid Loss and Rheology Tests

| | Fluid Loss | | | | | | | | | | | |
|---|---|---|---|---|---|---|---|---|---|---|---|---|
| | Control Additive | | API Fluid | | | | | | | | | |
| | CFR ®-8 | UCARE ™ | Loss Tests | | Rheology Tests at 80° F. | | | | | | | |
| | Cement | Polymer | | Fluid | Viscometer Readings | | | | | | | |
| | Dispersant | LK | Temp | Loss | 600 | 300 | 200 | 100 | 60 | 30 | 6 | 3 |
| Sample | (% by wt) | (% by wt) | (° F.) | (cc/30 min) | RPM | RPM | RPM | RPM | RPM | RPM | RPM | RPM |
| No. 1 | — | — | 140 | No | 78 | 32 | 23 | 12 | 8 | 5 | 2 | 2 |
| | | | | Control | | | | | | | | |
| No. 2 | — | 100 | 140 | 50 | 300+ | 300+ | 300+ | 300+ | 300+ | 300+ | 95 | 56 |
| No. 3 | 80 | 20 | 140 | 50 | 192 | 95 | 64 | 33 | 20 | 10 | 2 | 1 |
| No. 4 | 70 | 30 | 140 | 48 | 276 | 158 | 111 | 60 | 38 | 20 | 5 | 2 |
| No. 5 | 60 | 40 | 140 | 38 | 300+ | 246 | 182 | 104 | 68 | 38 | 9 | 4 |
| No. 6 | 60 | 40 | 200 | 72 | 300+ | 246 | 182 | 104 | 68 | 38 | 9 | 4 |
| No. 7 | 50 | 50 | 140 | 32 | 300+ | 300+ | 265 | 155 | 104 | 60 | 15 | 6 |
| No. 8 | 50 | 50 | 190 | 90 | 300+ | 300+ | 265 | 155 | 104 | 60 | 15 | 6 |

Thus, Example 1 demonstrates, inter alia, that the use of a fluid loss control additive comprising cationic cellulose ethers provides fluid loss control and desired rheology.

### EXAMPLE 2

Sample Cement Composition No. 9 was prepared having a density of 16.76 ppg and comprising water, Portland cement, sodium chloride (18% bwoc), and a fluid loss control additive (1% bwoc). The composition of the fluid loss control additive was 60% by weight CFR®-8 cement dispersant and 40% by weight UCARE™ Polymer LK. The fluid loss was found to be 50 cubic centimeters.

Sample Cement Composition No. 10 was prepared having a density of 16.76 ppg and comprising water, Portland cement, salt in the amount of 18% bwoc, and a fluid loss control additive (1% bwoc). The fluid loss control additive used in this sample was Halad® 322 cement additive, a mixture of 80% CFR®-3 and 20% hydroxyethyl cellulose with 1.5 moles of ethylene oxide substitution, available from Halliburton Energy Services, Inc., Duncan, Okla.

After preparation, each sample cement composition was poured into a preheated cell with a 325 mesh screen, and a fluid loss test was performed for 30 minutes at 1000 psi and 140° F. The fluid loss tests were performed in accordance with API RP 10B, Recommended Practices for Testing Well Cements. Additionally, the rheological properties of sample cement compositions were also determined using a Fann® Model 35 viscometer at 80° F. in accordance with the above mentioned API Specification RP 10B. The results of these tests are given in Table 2 below.

TABLE 2
API Fluid Loss and Rheology Tests in 18% Sodium Chloride Solution

| | Fluid Loss Control Additive | | | | | | | | | | | |
|---|---|---|---|---|---|---|---|---|---|---|---|---|
| | | | HALAD ® | API | | | | | | | | |
| | CFR ®-8 | UCARE ™ | 322 | Fluid | Rheology Tests at 80° F. | | | | | | | |
| | Cement | Polymer | Cement | Loss at | Viscometer Readings | | | | | | | |
| | Dispersant | LK | Additive | 140° F. | 600 | 300 | 200 | 100 | 60 | 30 | 6 | 3 |
| Sample | (% by wt) | (% by wt) | (% by wt) | (cc/30 min) | RPM | RPM | RPM | RPM | RPM | RPM | RPM | RPM |
| No. 9 | 60 | 40 | — | 50 | 300+ | 300+ | 300+ | 272 | 180 | 109 | 29 | 16 |
| No. 10 | — | — | 100 | 112 | 214 | 119 | 81 | 43 | 27 | 15 | 5 | 4 |

Thus, Example 2 demonstrates, inter alia, that the use of a fluid loss control additive comprising cationic cellulose ethers in cement compositions that comprise salt provides fluid loss control and desired rheology.

### EXAMPLE 3

Sample Cement Composition No. 11 was prepared having a density of 16.4 ppg and comprising water, Portland cement, SSA-2 strength stabilizing agent (35% bwoc), a fluid loss control additive (1% bwoc), and HR®-5 retarder (0.2% bwoc). The composition of the fluid loss control additive was 60% by weight CFR®-8 cement dispersant and 40% by weight UCARE™ Polymer LK.

Sample Cement Composition No. 12 was prepared having a density of 16.4 ppg and comprising water, Portland cement, SSA-2 strength stabilizing agent (35% bwoc), a fluid loss control additive (1% bwoc), and HR®-5 retarder (0.35% bwoc). The composition of the fluid loss control additive was 60% by weight CFR®-8 cement dispersant and 40% by weight UCARE™ Polymer LK.

Sample cement composition 13 was prepared having a density of 16.4 ppg and comprising water, Portland cement, SSA-2 strength stabilizing agent (35% bwoc), and a fluid loss control additive (1% bwoc). The composition of the fluid loss control additive was 60% by weight CFR®-8 cement dispersant and 40% by weight UCARE™ Polymer LK.

After preparation, each sample cement composition was subjected to thickening time tests in accordance with the above-mentioned API Specification RP 10B. The thickening time for each to sample to 70 Bearden units of consistency (“bc”) is shown in Table 3 below.

TABLE 3
Thickening Time Tests

| | Fluid Loss | | | | |
|---|---|---|---|---|---|
| | Control Additive | | | | |
| | CFR ®-8 | UCARE ™ | | | |
| | Cement | Polymer | HR ®-5 | | Thickening |
| | Dispersant | LK | Retarder | Temp | Time to 70 bc |
| Sample | (% by wt) | (% by wt) | (% bwoc) | (° F.) | (hr:min) |
| No. 11 | 60 | 40 | 0.2 | 140 | 5:57 |
| No. 12 | 60 | 40 | 0.35 | 190 | 13:12 |
| No. 13 | 60 | 40 | — | 140 | 4:25 |

Thus, Example 3 demonstrates, inter alia, that cement compositions comprising a fluid loss control additive comprising cationic cellulose ethers may provide acceptable thickening times.

### EXAMPLE 4

Sample Cement Composition No. 14 was prepared having a density of 16.4 ppg and comprising water, Portland cement, SSA-2 strength stabilizing agent (35% bwoc), a fluid loss control additive (1% bwoc), and HR®-5 retarder (0.2% bwoc). The composition of the fluid loss control additive was 60% by weight CFR®-8 cement dispersant and 40% by weight UCARE™ Polymer LK.

Sample Cement Composition No. 15 was prepared having a density of 16.4 ppg and comprising water, Portland cement, SSA-2 strength stabilizing agent (35% bwoc), a fluid loss control additive (1% bwoc), and HR®-5 retarder (0.35% bwoc). The composition of the fluid loss control additive was 60% by weight CFR®-8 cement dispersant and 40% by weight UCARE™ Polymer LK.

After preparation, each sample cement composition was subjected to 48-hour compressive strength tests in accordance with the above-mentioned API Specification RP 10B. The results of these compressive strength tests are given in Table 4 below.

TABLE 4
Compressive Strength Tests

| | Fluid Loss | | | | |
|---|---|---|---|---|---|
| | Control Additive | | | | |
| | CFR ®-8 | UCARE ™ | | | 48-Hour |
| | Cement | Polymer | HR ®-5 | | Compressive |
| | Dispersant | LK | Retarder | Temp | Strength |
| Sample | (% by wt) | (% by wt) | (% bwoc) | (° F.) | (psi) |
| No. 14 | 60 | 40 | 0.2 | 190 | 2,890 |
| No. 15 | 60 | 40 | 0.35 | 235 | 3,780 |

Thus, Example 4 demonstrates, inter alia, that cement compositions comprising a fluid loss control additive comprising cationic cellulose ethers may provide acceptable compressive strength.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. In particular, every range of values (of the form, “from about a to about b,” or, equivalently, “from approximately a to b,” or, equivalently, “from approximately a-b”) disclosed herein is to be understood as referring to the power set (the set of all subsets) of the respective range of values, and set forth every range encompassed within the broader range of values. Also, the terms in the claims have their plain, ordinary meaning unless otherwise explicitly and clearly defined by the patentee.

1. A cement composition comprising:
a cement;
water; and
a fluid loss control additive consisting essentially of a graft copolymer having a backbone of a condensation product of formaldehyde, acetone and sodium bisulfite, the graft copolymer present in an amount in the range of from 50% to 80% by weight of the fluid loss control additive, and a cationic cellulose ether in an amount in the range of from 20% to 50% by weight of the fluid loss control additive, the cationic cellulose ether comprising a backbone of anhydroglucose units and a plurality of positively charged substituent groups spaced along the backbone.

2. The cement composition of claim 1 wherein the cement comprises a hydraulic cement.

3. The cement composition of claim 1 wherein the fluid loss control additive is present in the cement composition in amount in the range from about 0.5% to 2% by weight of cement.

4. The cement composition of claim 1 wherein the cationic cellulose ether comprises a quaternized hydroxyethyl cellulose with about 2 to about 2.5 moles of ethylene oxide substitution.

5. The cement composition of claim 1 wherein the plurality of positively charged substituent group comprises an ether group comprising a quaternary-nitrogen radical.

6. The cement composition of claim 1 wherein the cationic cellulose ether is of the general formula: 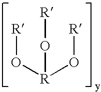
wherein R is the anhydroglucose backbone, y is an integer having a value of from about 50 to about 20,000, and each R′ individually represents a substituent group of the general formula: 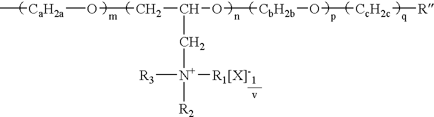
wherein:
a is in an integer having a value of from 2 to 3;
b is an integer having a value of from 2 to 3;
c is an integer having a value of from 1 to 3;
m is an integer having a value of from 0 to 10;
n is an integer having a value of from 0 to 3;
p is an integer having a value from 0 to 10;
q is an integer having a value from 0 to 1;
R″ is a member selected from the group consisting of: 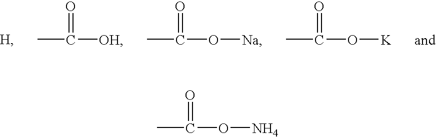
wherein R″ is H, when Q is O;
R₁, R₂, and R₃ are individually selected from the group consisting of an alkyl, an aryl, an aralkyl, an alkaryl, a cycloalkyl, an alkoxyalkyl, and an alkoxyaryl radical, wherein each R₁, R₂, and R₃ can contain up to 10 carbon atoms, wherein when R₁, R₂, or R₃ are an alkoxyalkyl radical, there are at least 2 carbon atoms separating the oxygen atom from the nitrogen atom, and wherein the total number of carbon atoms in radicals represented by R₁, R₂, and R₃ is from 3 to 12;
R₁, R₂, and R₃, taken together along with the nitrogen atom to which they are attached, represent a pyridine, a α-methylpyridine, a 3,5-dimethylpyridine, a 2,4,6-trimethylpyridine, a N-methyl piperidine, a N-ethyl piperidine, a N-methyl morpholine, or a N-ethyl morpholine;
X is an anion;
V is an integer which is equal to the valence of X;
the average value of n per anhydroglucose unit is from about 0.01 to about 1; and
the average value of m+n+p+q per anhydroglucose unit is from about 0.01 to about 4.

7. The cement composition of claim 6 wherein X is selected from the group consisting of chloride, bromide, iodide, sulfate, methylsulfate, sulfonate, nitrate, phosphate, and acetate.

8. The cement composition of claim 6 wherein the average value of n per anhydroglucose unit is from about 0.01 to about 0.5.

9. The cement composition of claim 6 the average value of m+n+p+q per anhydroglucose unit is from about 0.1 to about 2.5.

10. (canceled)

11. The cement composition of claim 1 wherein a 2% by weight solution of the cationic cellulose ether has a viscosity in the range of from about 300 centipoise to about 500 centipoise as measured by a Brookfield viscometer at 25° C.

12-20. (canceled)

21. The cement composition of claim 1 wherein the cationic cellulose ether is present in the cement composition in an amount of about 0.5% by weight of the cement, and wherein the cement composition has a maximum API fluid loss of 50 cubic centimeters per 30 minutes at 140° F. and 1000 pounds per square inch.

22. A cement composition comprising:
a cement;
water; and
a fluid loss control additive consisting essentially of a graft copolymer having a backbone of a condensation product of formaldehyde, acetone and sodium bisulfite, and a cationic cellulose ether, wherein the fluid loss control additive has a graft copolymer to cationic cellulose ether weight ratio of in the range of from 4:1 to 1:1, and wherein the fluid loss control additive is present in the cement composition in an amount sufficient for the cement composition to have a maximum API fluid loss of 50 cubic centimeters per 30 minutes at 140° F. and 1000% pounds per square inch.

23. The cement composition of claim 22 wherein the cationic cellulose ether comprises a quaternized hydroxyethyl cellulose with about 2 to about 2.5 moles of ethylene oxide substitution.

24. The cement composition of claim 22 wherein the cationic cellulose ether is of the general formula: 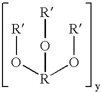
wherein R is the anhydroglucose backbone, y is an integer having a value of from about 50 to about 20,000, and each R′ individually represents a substituent group of the general formula: 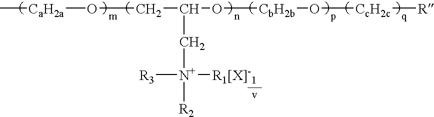
wherein:
a is in an integer having a value of from 2 to 3;
b is an integer having a value of from 2 to 3;
c is an integer having a value of from 1 to 3;
m is an integer having a value of from 0 to 10;
n is an integer having a value of from 0 to 3;
p is an integer having a value from 0 to 10;
q is an integer having a value from 0 to 1;
R″ is a member selected from the group consisting of: 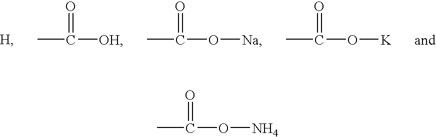
wherein R″ is H, when Q is O;
R₁, R₂, and R₃ are individually selected from the group consisting of an alkyl, an aryl, an aralkyl, an alkaryl, a cycloalkyl, an alkoxyalkyl, and an alkoxyaryl radical, wherein each R₁, R₂, and R₃ can contain up to 10 carbon atoms, wherein when R₁, R₂, or R₃ are an alkoxyalkyl radical, there are at least 2 carbon atoms separating the oxygen atom from the nitrogen atom, and wherein the total number of carbon atoms in radicals represented by R₁, R₂, and R₃ is from 3 to 12;
R₁, R₂, and R₃, taken together along with the nitrogen atom to which they are attached, represent a pyridine, a α-methylpyridine, a 3,5-dimethylpyridine, a 2,4,6-trimethylpyridine, a N-methyl piperidine, a N-ethyl piperidine, a N-methyl morpholine, or a N-ethyl morpholine;
X is an anion;
V is an integer which is equal to the valence of X;
the average value of n per anhydroglucose unit is from about 0.01 to about 1; and
the average value of m+n+p+q per anhydroglucose unit is from about 0.01 to about 4.

25. The cement composition of claim 22 wherein the fluid loss control additive is present in the cement composition in amount in the range from about 0.5% to 2% by weight of cement.

26. The cement composition of claim 22 wherein the cationic cellulose ether is present in the cement composition in an amount of about 0.5% by weight of the cement.

27. (canceled)
